(19) United States
(12) Patent Application Publication
(10) Pub. No.: US 2012/0217096 A1
(43) Pub. Date: Aug. 30, 2012

(54) Stair-avoiding device

(76) Inventor: Tibor Zoltan Harmathy, Ottawa (CA)

(21) Appl. No.: 12/932,319

(22) Filed: Feb. 24, 2011

(51) Int. Cl. B66B 9/02

(52) U.S. Cl. 187/267

(57) ABSTRACT

With an aging population, stair safety is a growing concern. Many inventions have been suggested to aid older people in handling stairs. Most of them offer sitting arrangements that are moved by rather complex motor-driven devices attached to one side of the stairs. These devices are complicated and expensive. A new device is suggested that consists of a vertical pole turned by a reversible motor, thereby moving the platform up or down. The platform carries standing person(s) one by one, or two or three in a group, or one sitting in wheelchair from one floor to the next above or down below. This device is inexpensive, can be used with stairs interrupted by landings or with spiral staircase, and does not require the changing or redistribution of the designed building spaces.

### BRIEF SUMMARY

With the population getting older, a simple and inexpensive device is suggested for avoiding falling while climbing the stairs between floors.

### REFERENCE TO RELATED APPLICATIONS

All US Patents in File 54

Example: US Publication No. U.S. 2008/0128213 A1

### BRIEF DESCRIPTION OF DRAWINGS

FIG. 1: the device itself

FIG. 2: cross section of the device, showing the platform

FIG. 3: example of the suggested location of the device in the stair arrangement

### DESCRIPTION OF THE DEVICE

With more and more people surviving into their eighties or even nineties, it becomes important to know the principal causes of death. Statistics shows that one of the most frequent causes of death is falling, most often on stairs. Many inventions have been aimed at preventing the fall of elderly or disadvantaged people on stairs, or just making the climbing of stairs easier for healthy people. Most of these inventions are placed in File 54 of the US Patent Publications. Of the many patents the one that seems to gain acceptance is the so-called chairlift that carries sitting people along the stairs. The device is driven by a mechanism on one side of the stairs. The disadvantage of this device is the high cost, especially in residential buildings, where to save space the stair sections are steep and often interrupted by one or more landings, or for the same reason spiral staircase is selected. The invention to be described here is a simple inexpensive design, and requires little redistribution of the building spaces. It is particularly suitable for use in residential two-story buildings. Its use in multistory buildings is also possible, but it is recommended that the here described arrangement be repeated for each story.

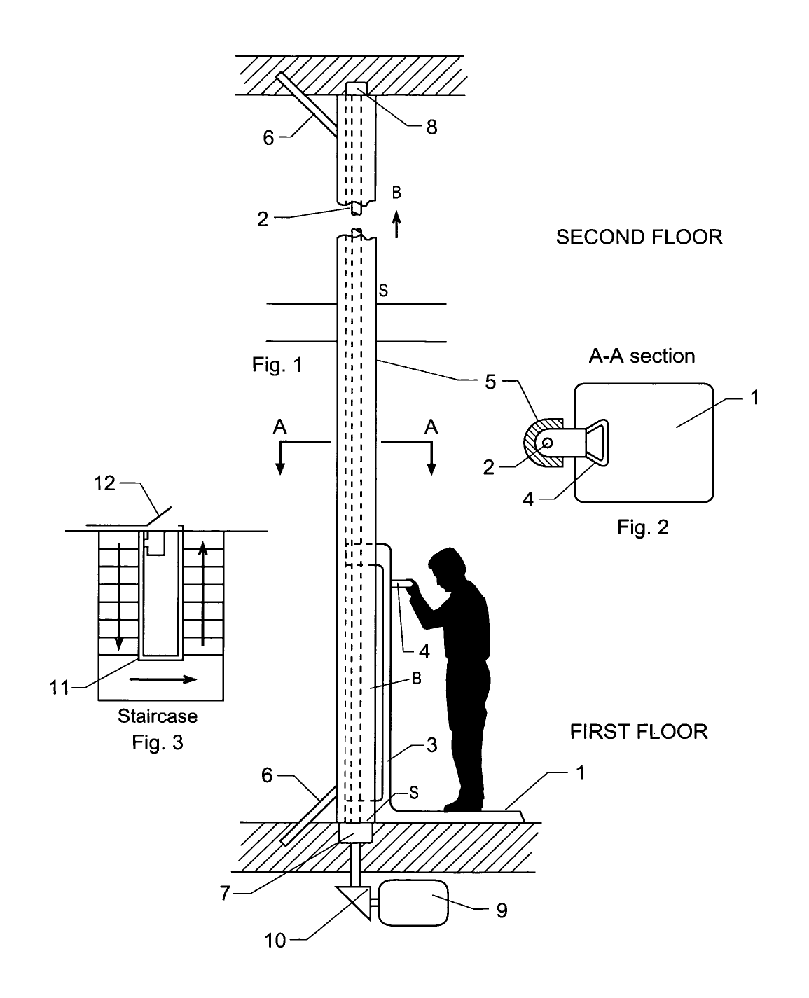

Since the movement of people from story to story usually takes no more than one or two minutes, having a stair climber that offers the convenience of sitting during this time is an unnecessary luxury. As FIG. 1 shows, the recommended arrangement is that a very limited number of standing people and their belongings or one person sitting in a wheelchair be transported on small platform, 1, which moves up or down by virtue of the turning of a vertical pole, 2, fitted out with male thread, and joins the platform fitted out with female thread, The platform has a vertical extension, 3, to withstand the moment exerted by the load carried, and a handle, 4, at an appropriate height to stabilize the person{s} standing or sitting in wheelchair on the platform. To ensure the vertical movement of the platform, the pole is encased in a fixed U-shaped vertical guide, 5, which is opened on one side to allow the joining of the pole and the platform. The guide is fixed by two claws, 6. The pole turns right or left in a supporting bearing at the bottom, 7, and an ordinary bearing, 8, at the ceiling of the floor above. The turning is provided by a reversible motor, 9, through cogwheels, 10.

The rest of this device concerns the electric arrangement for starting and stopping the motor. These are commercially available components and do not form part of this invention. The starting and returning buttons could be located on the guide, or on a board running parallel to the pole. In FIG. 1 the former arrangement is assumed. The possible location of buttons is shown in FIG. 1, indicated by the letter B. The possible location of the stop-switches is also shown in FIG. 1, indicated by the letter S.

FIG. 2 shows a cross section of the devise and the platform. FIG. 3 shows an example of a staircase with two flights of stairs and a landing. The handrails are shown as lines, 11. The recommended position of the stair-avoiding device is also shown. The handrail on the upper floor should have an openable section, 12, where people can disembark or enter the device to move down.

What I claim as my invention is:

1. Device for carrying people from one floor to the next above or moving them down to the floor below along a turning threaded pole, the people standing or one person sitting in a wheelchair on a platform.

2. The platform defined in claim 1 is not larger than enough to accept a wheelchair.

3. The platform defined in claim 1 has female thread and joins the pole fitted out with male thread.

4. The platform defined in claim 1 joins the pole along a distance necessary to withstand the moment of the load on the platform.

5. The pole defined in claim 1 is turnable electrically in both directions.

6. The pole defined in claim 1 is encased in a fixed U-shaped guide, the opening of the U being on the side of the platform to allow the joining and up or down movement of the platform along the pole.

7. The buttons that start the turning of the pole and the switches that stop the turning are placed on the outside of the U-shaped guide.

8. The buttons that start the turning of the pole and the switches that stop the turning are placed on one or more boards placed beside the guide.
